(19) United States
(12) Patent Application Publication
(10) Pub. No.: US 2016/0345405 A1
(43) Pub. Date: Nov. 24, 2016

(54) Solid state lighting control device

(71) Applicant: Drew Forrest Vigen, Reno, NV (US)

(72) Inventor: Drew Forrest Vigen, Reno, NV (US)

(21) Appl. No.: 14/715,532

(22) Filed: May 18, 2015

(51) Int. Cl. H05B 37/02

(52) U.S. Cl. CPC H05B 37/0227; H05B 37/0245; H05B 37/0236

(57) ABSTRACT

Methods and systems are provided for the control of solid state lighting as applied to general illumination environments, architectural, and accent lighting. The invention as detailed provides a system according to some embodiments that includes a dynamic controller that provides control signals to a solid state lighting driver or multiple drivers at the location where the user interface for said control is located and that are configured to provide 0 and 100 per cent of maximum brightness control to one or multiple separately located solid state lighting emitters enclosed in what could be called a light fixture or fixtures.

### FIELD OF THE INVENTION

The present invention relates to solid state lighting, particularly, the control of solid state light emitter fixtures.

### BACKGROUND OF THE INVENTION

The design and invention of general illumination lighting derived from electricity began in the late 1,800.s, and was popularized by inventors Tesla and Edison and commercialized by Westinghouse and General Electric. This original system provided for the distribution of alternating current and it's connection to a filament lamp controlled by a blade switch. This system has progressed over the last about 130 years, but in general still maintains the same basis of distributing alternating current over physical wires, with the expansion of control from a single switch to dimmers to highly connected digitally connected devices, and the filament lamp to many styles of light emitting devices. This core system is commonly referred to a “Legacy” system, and is referred to as such throughout this.

The large proliferation of Legacy systems in building structures throughout the world has maintained, expanded, and continued adaption of lighting control and lighting fixtures to this Legacy standard even though solid state lighting is derived from direct current. The early adaptation of solid state lighting was the integration of a driver circuit, one to multiple light emitting diodes, and an alternating current (AC) to direct current (DC) conversion circuit tightly integrated in a Legacy type lamp, commonly called a LED lamp. Problems arose from this initial design. First, heat from the driver, AC to DC voltage conversion, and the Emitter caused a short life of the LED lamp. Second, the emitter color changed with age, mostly caused by the heat, Third, Legacy dimmers did not function because they did not work with the zero voltage crossing of AC and the reduced voltage at low lighting levels was below what the driver would output to the emitter.

The next generation of solid state lighting into Legacy systems progressed with dimmers modified to address the voltage issues (and other technical improvements), and Legacy LED lamps with greater heat dissipating capacity but this just improved existing integration issues.

A third generation of solid state lighting into Legacy systems progressed with placing control circuits inside of Legacy LED lamps. These systems are dependent on AC distribution and can have a control switch in the circuit, but primarily derive lighting lamp/fixture control through a communications path generally conforming to a published standard such as DALI, ZigBee, WiFi, DMX, Sub-1 Ghz, IEEE 802,xx, 0-10 volt, or other published proprietary format. Some of these controls are commonly found in stage and theatrical lighting systems or integrated into a centralized building automation communication system hub. Heat and other existing issues still exist.

Today the fourth and current generation trend in the world is now toward the concept of the loT (Internet of Things), where every end product has a IP communications connection to the internet and interfaces to smartphone app's (application) for control, generally over WiFi, ZigBee, and/or Bluetooth. And heat and other existing issues still exist. Many inefficacies and redundancies exist in the current Legacy solid state lighting systems today. This invention addresses most of these, as an example is the concentration of a cumulative single source of heat derived from the integration of power conversion, control circuit, driver circuit and solid state lighting emitter(s) in a single enclosure and its continued thermal damage to the entire Legacy LED lamp. Other items addressed or eliminated fixture by this invention, by separating all components at the light are multiple points of voltage conversion in the system, basic elimination of AC to DC conversion, elimination of under and over AC voltage and voltage ripple, very high voltage spikes, DC isolation from dangerous AC current levels, flicker in dimming from AC injection in circuit, reduction in the complexity of driver circuit components, single source of user interface for control at traditional Legacy location, and EMI and rf reduction or elimination,

### SUMMARY OF THE INVENTION

The intended outcome benefits of this solid state lighting control device invention to a solid state lighting system in general are the elimination of centralized heat concentrations at each singular solid state lighting lamp, reduced wire sizes in the wiring distribution complexity and there installed wiring cost, creation of a singular centralized control point distribution location for solid state lighting drivers who's location is similar in use to traditional Legacy system locations, and to eliminate or isolate the dangers of AC power distribution to solid state emitter lighting fixtures. Additional intended outcomes of separating the heat conducting parts of a solid state lighting emitter from the solid state lighting control and driver circuitry are the reduction of the size and requirement of heat sinking at the solid state lighting emitters therefore extending the life of the solid state lighting emitters, plus as an additional benefit will be to provide for the reduction in size of the solid state lighting fixture housings or enclosures. Although there is only a small reduction in overall system heat the thermal isolation of components allows more natural cooling without highly designed engineering and connected thermal auxiliary cooling components.

### BRIEF DESCRIPTION OF THE DRAWINGS

FIG. 1 is a block diagram of solid state lighting driver control system.

FIG. 2 is a constant current diagram for solid state lighting driver output to emitters.

FIG. 3 is a PWM timing diagram for solid state lighting driver output to emitters.

FIG. 4 is a block diagram of solid state lighting driver control system where user input being mechanically affixed to said solid state lighting control device.

FIG. 5 is a block diagram of solid state lighting driver control system where a remote control receiver being capable of receiving user input from a remote control transmitter is incorporated.

FIG. 6 is a block diagram of solid state lighting driver control system where a remote control transmitter being capable of transmitting user input and driver circuit state to a remote control receiver is incorporated.

FIG. 7 is a block diagram of solid state lighting driver control system where a microphone subsystem is integrated.

FIG. 8 is a block diagram of solid state lighting driver control system where a temperature detection subsystem is integrated.

FIG. 9 is a block diagram of solid state lighting driver control system where a security life safety device link subsystem is integrated.

FIG. 10 is a block diagram of solid state lighting driver control system where a building automation device link subsystem is integrated.

FIG. 11 is a block diagram of solid state lighting driver control system where an additional means of dynamically controlling said one or more additional driver circuits remote

FIG. 12 is a constant current diagram for additional solid state lighting driver output to emitters.

FIG. 13 is a PWM timing diagram for additional solid state lighting driver output to emitters.

FIG. 14 is a block diagram of solid state lighting driver control system where system where an user input being mechanically affixed to said additional solid state lighting control device.

FIG. 15 is a block diagram of solid state lighting driver control system where an additional remote control receiver being capable of receiving user input from a remote control transmitter is integrated.

FIG. 16 is a block diagram of solid state lighting driver control system where an additional remote control transmitter being capable of transmitting user input and driver circuit state to a remote control receiver is integrated.

FIG. 17 is a block diagram of solid state lighting driver control system where an additional microphone subsystem is integrated.

FIG. 18 is a block diagram of solid state lighting driver control system where an additional temperature detection subsystem is integrated.

FIG. 19 is a block diagram of solid state lighting driver control system where an additional security life safety device link subsystem is integrated.

FIG. 20 is a block diagram of solid state lighting driver control system where an additional building automation device link subsystem is integrated.

FIG. 21 is an interior view of where typical solid state lighting driver control system components might be located.

FIG. 22 is an interior view of where typical additional solid state lighting driver control system components might be located.

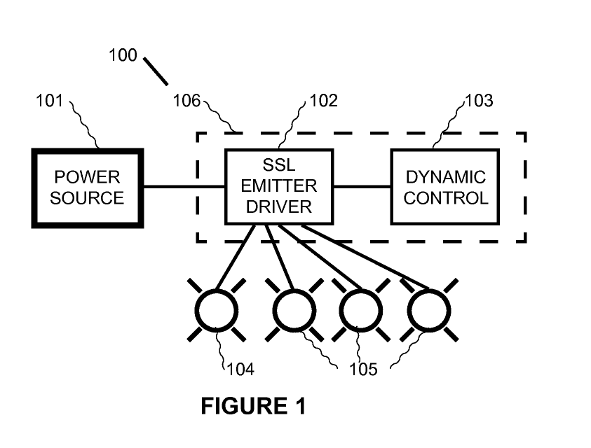

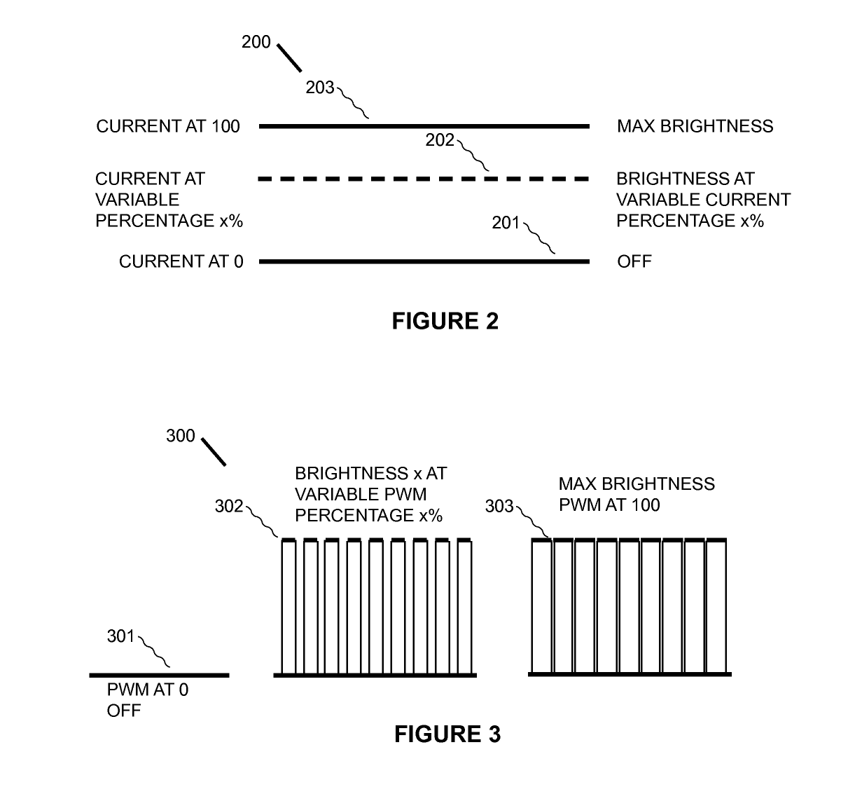

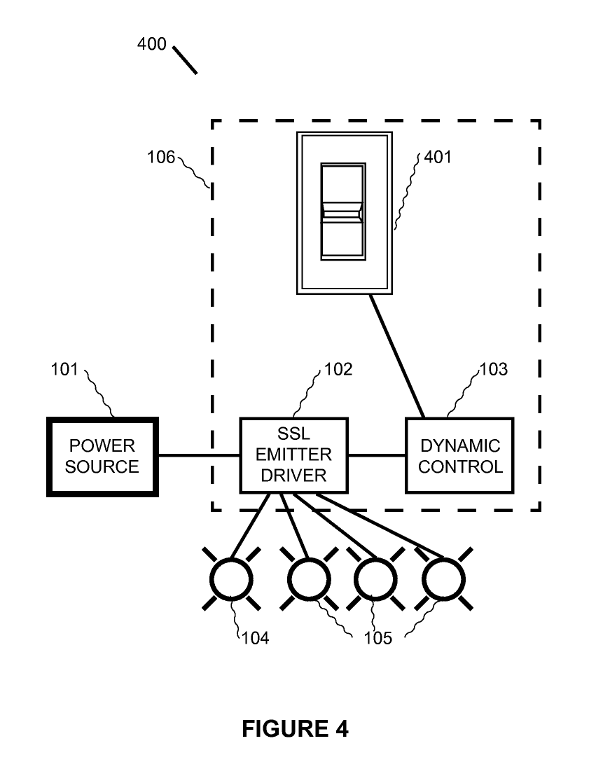

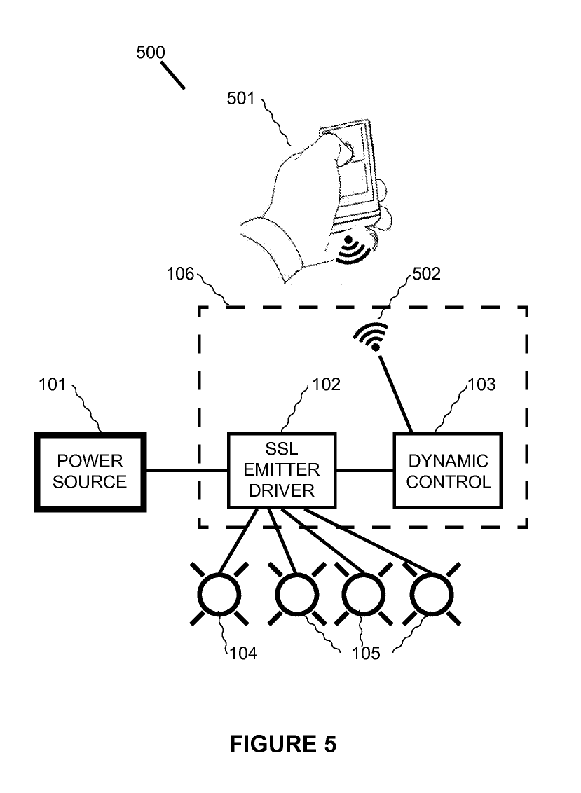

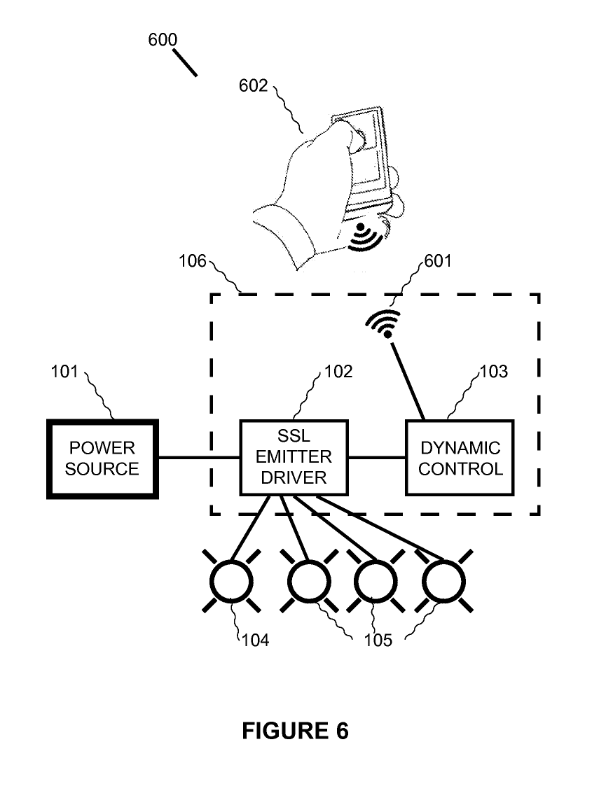

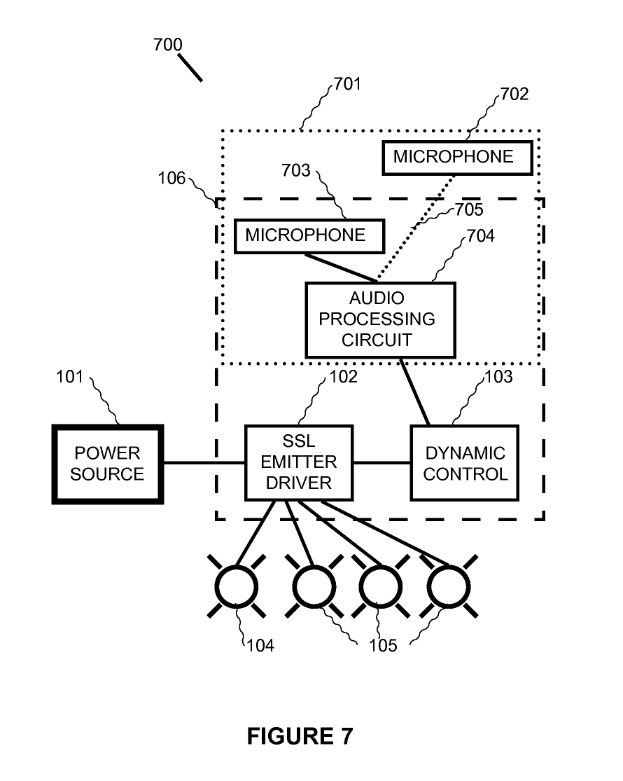

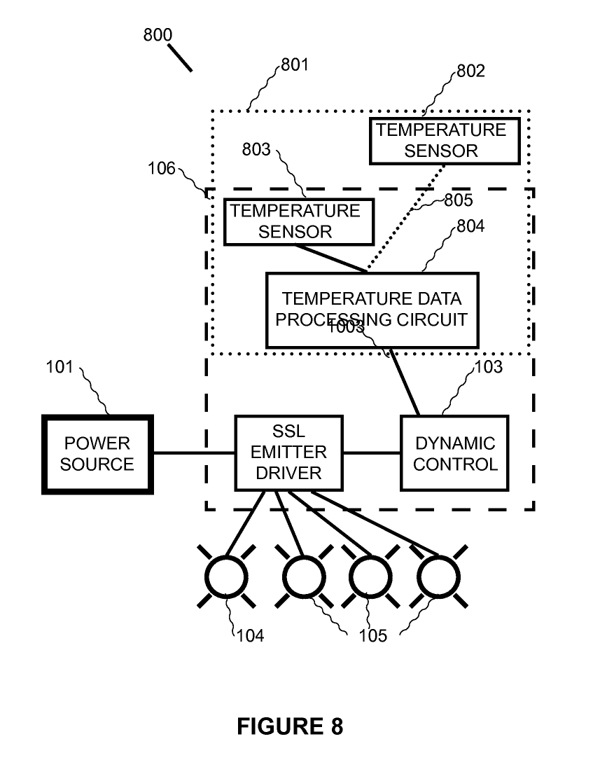

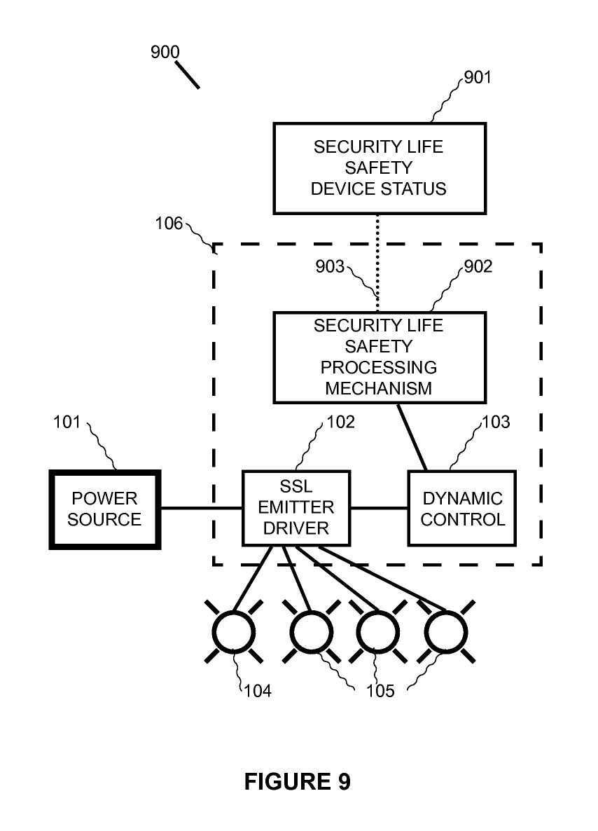

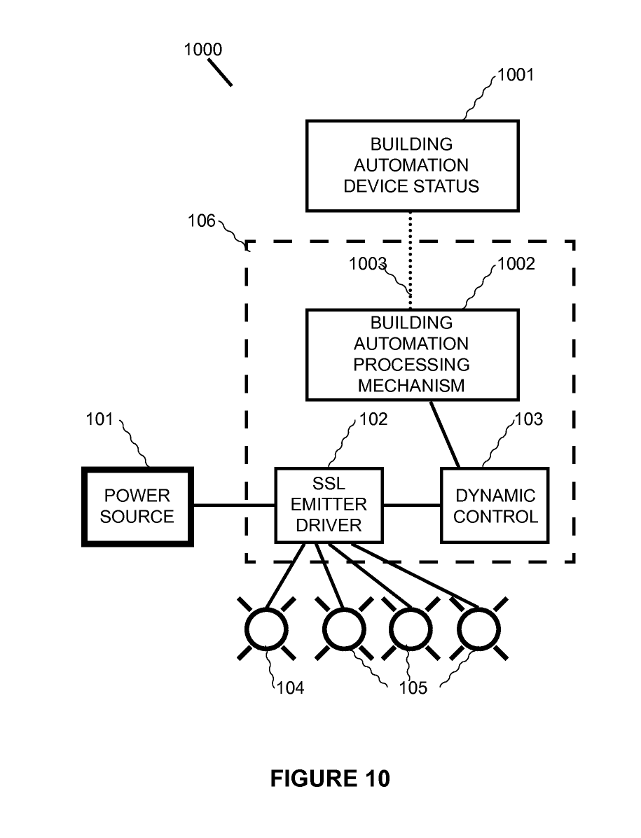

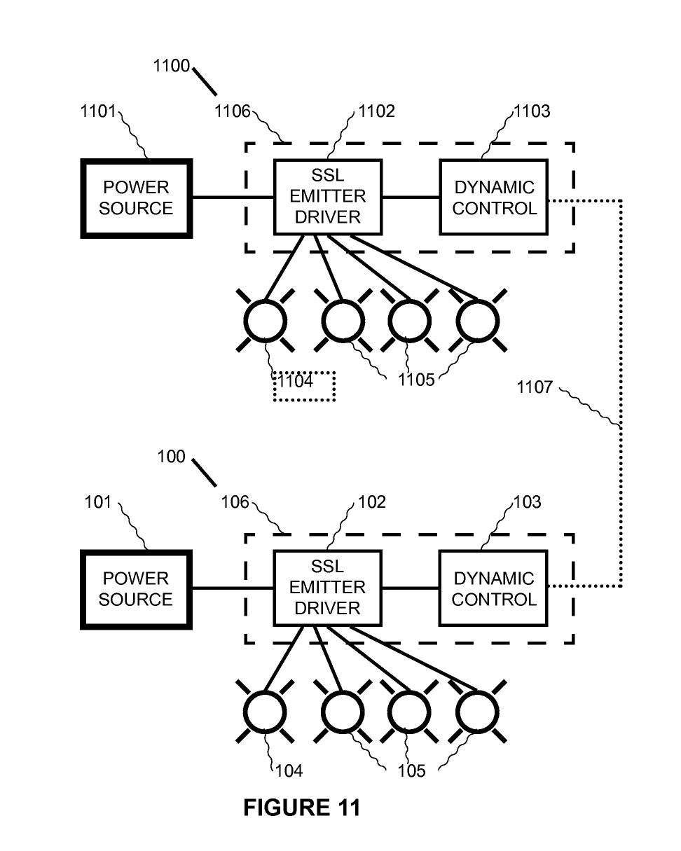

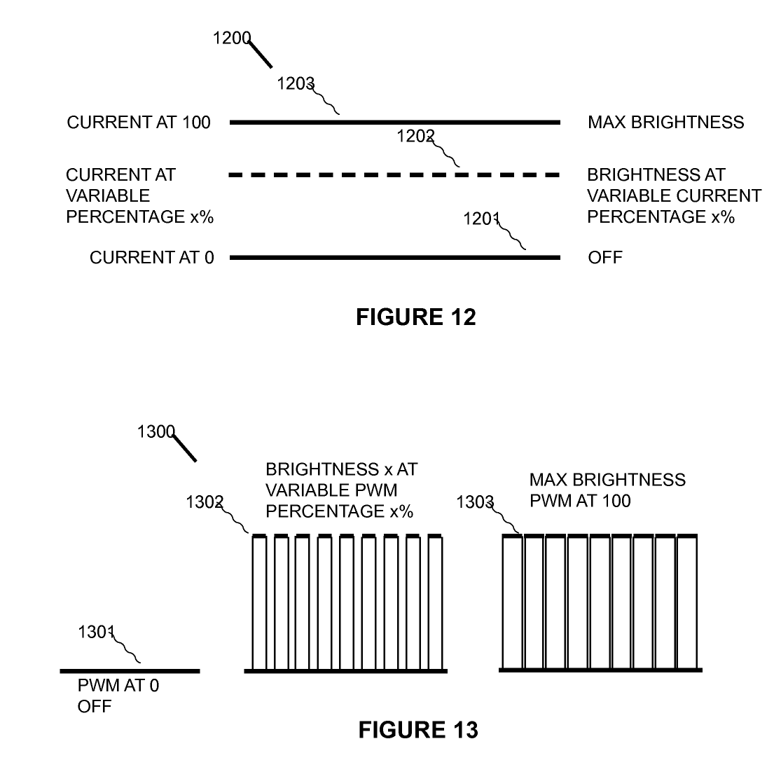

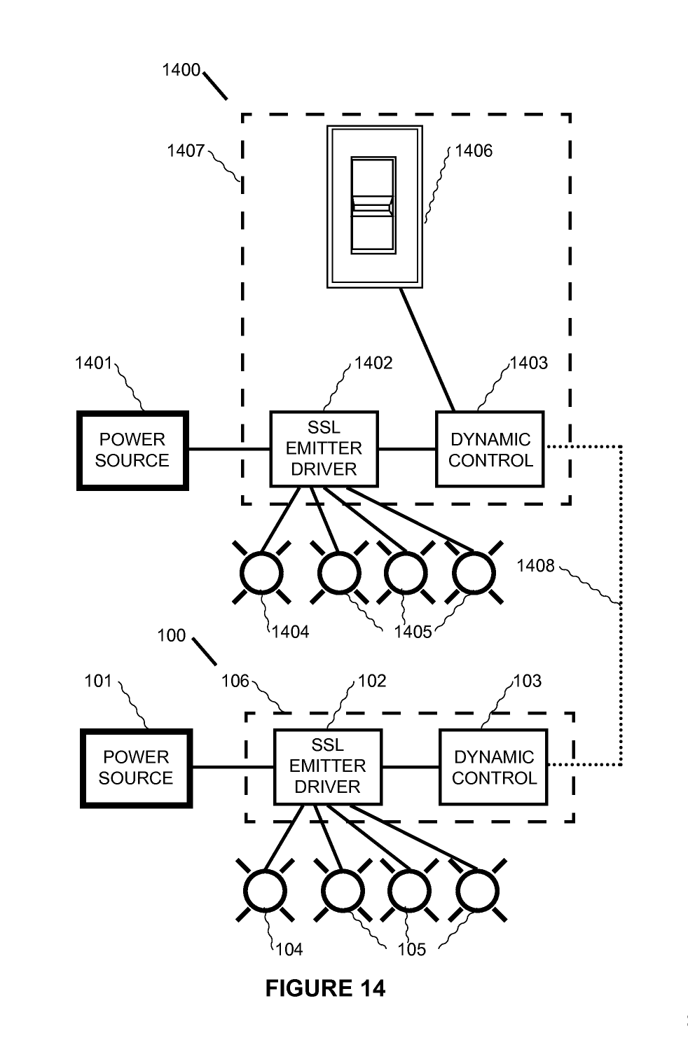

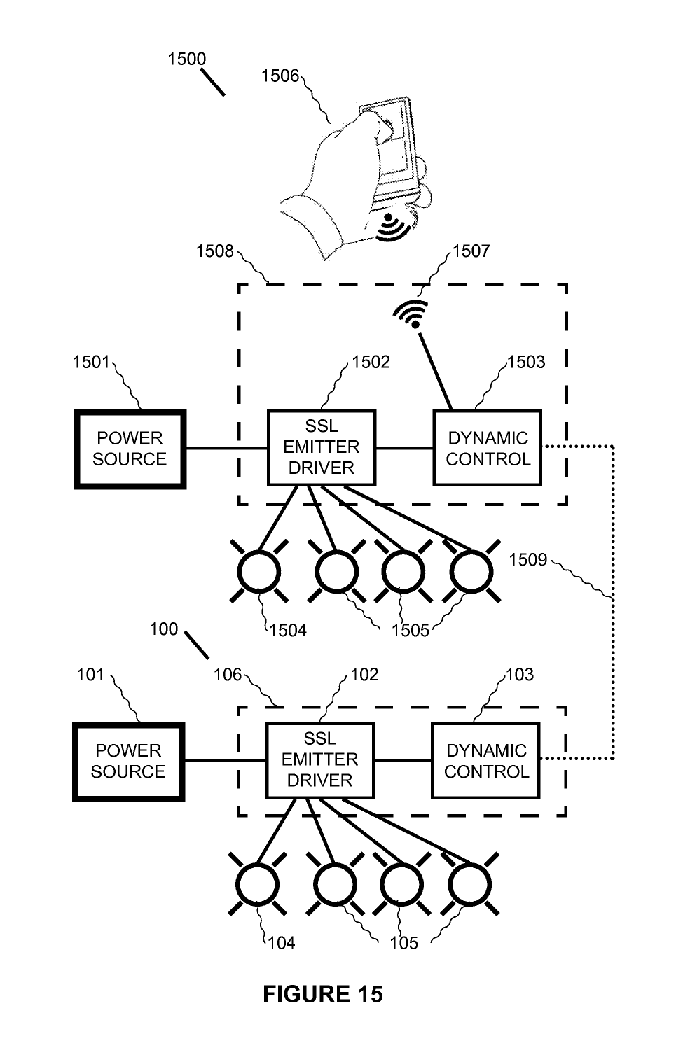

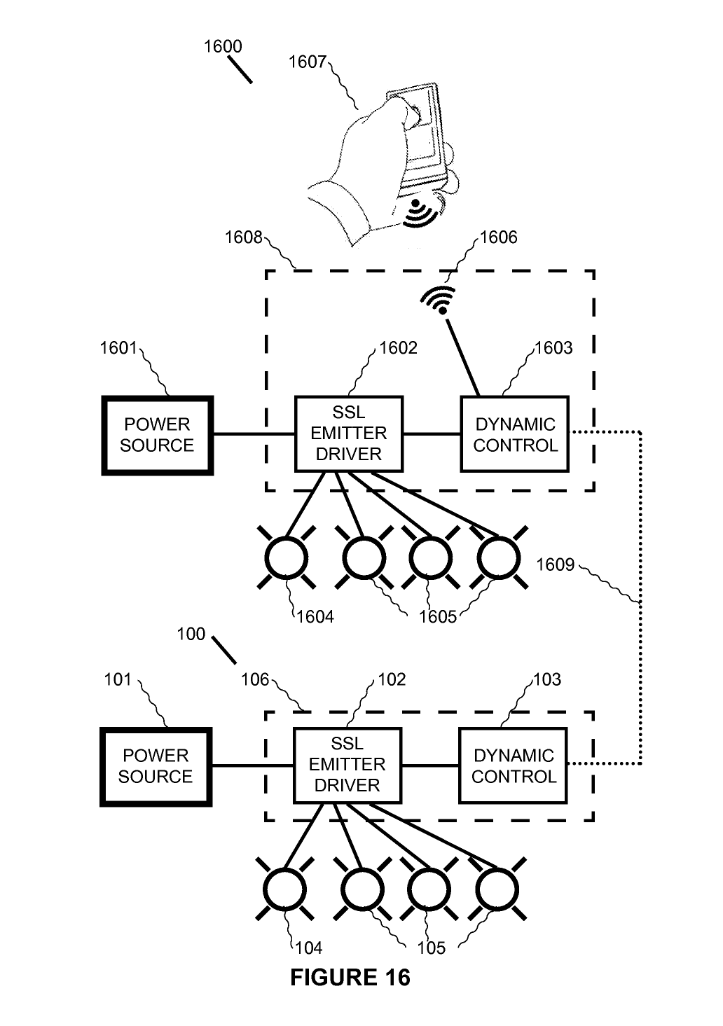

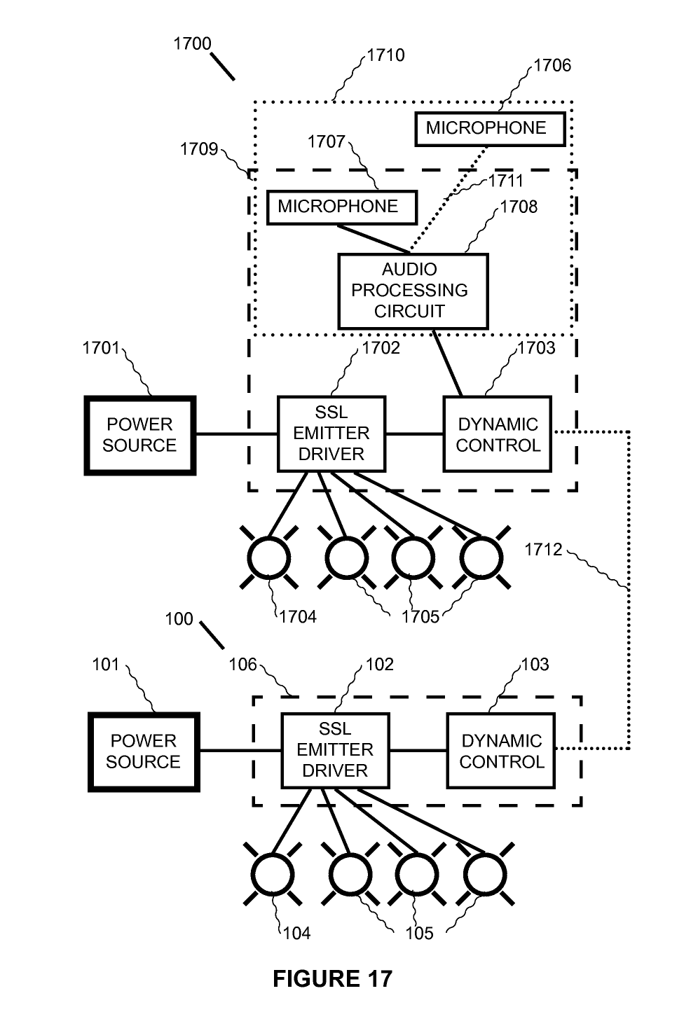

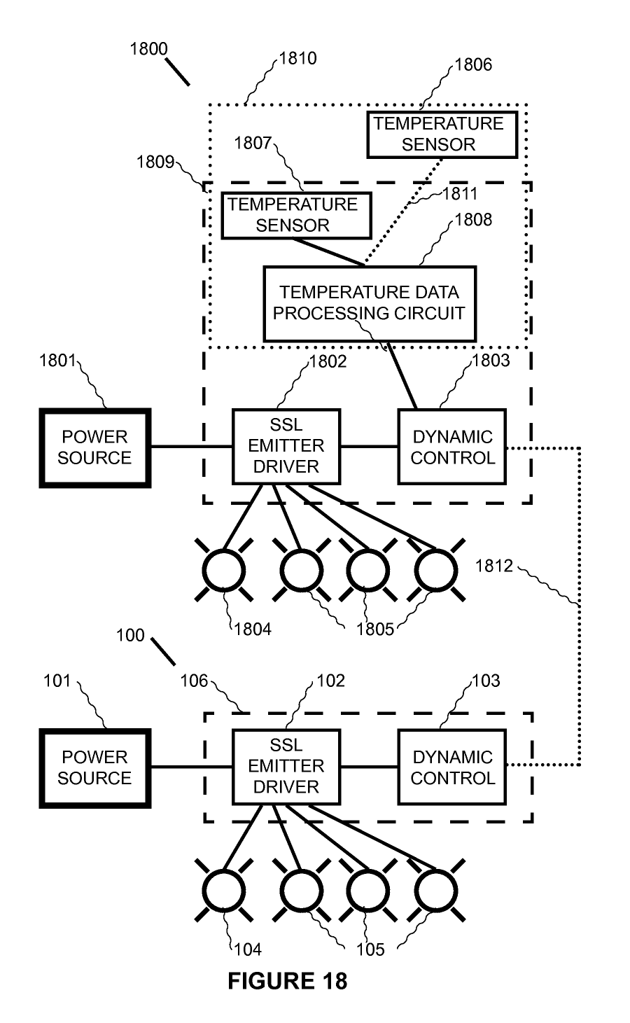

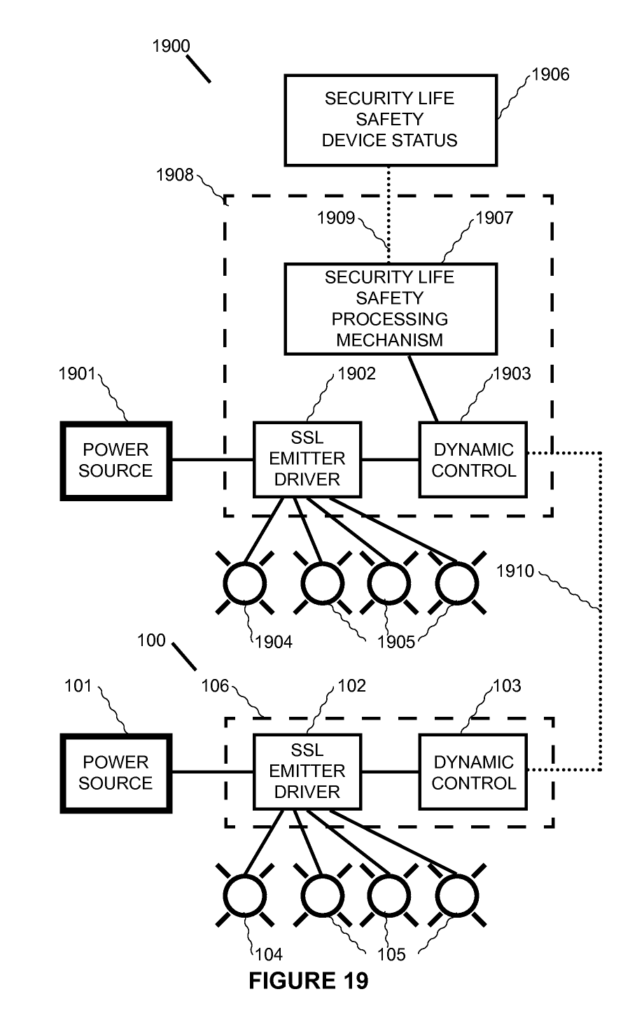

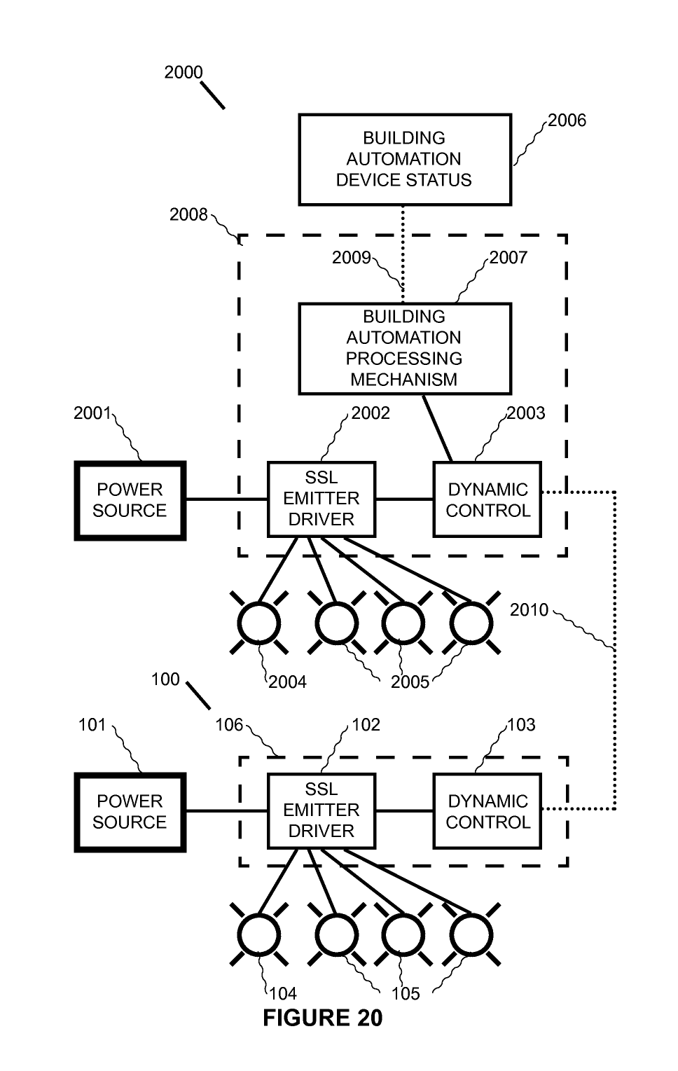

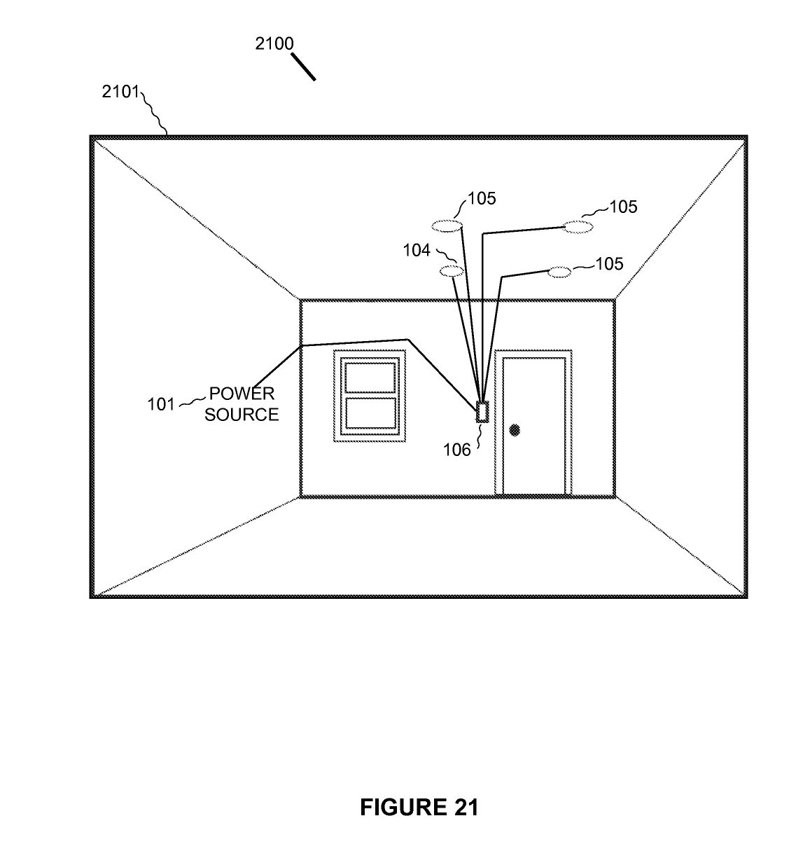

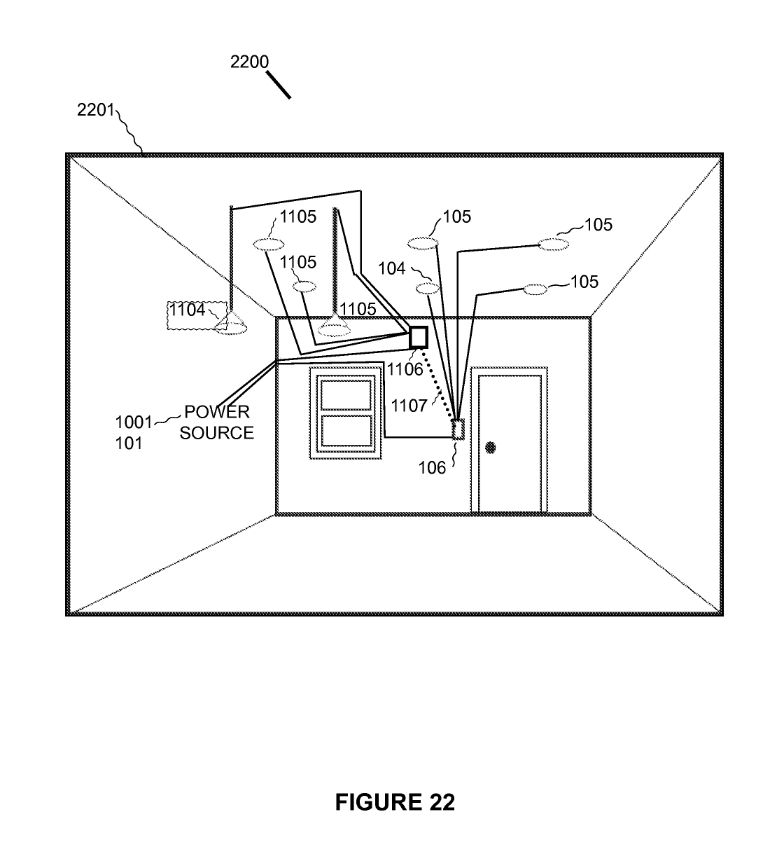

### DETAILED DESCRIPTION OF THE INVENTION

Since Direct Current (DC) distribution for solid state lighting emitters is not standard or common in building structures today the following embodiments of this invention may require a fundamental shift in how building structures are wired. In this embodiments, the solid state lighting control device (100, 1100) may include in a enclosure or housing (106). Where such enclosure or housing may be located (2101, 2201) to provide user input (401, 1401) or functionality selections to a control circuit (103, 1103) that may interoperate user inputs (401, 501, 1401, 1501) and then may process a logic schema, code or program or timer function that may output a desired digital or analog circuit that may emulate a function or required input variable which may be a relay, gate, field effect transistor, electronic switch, variable or selectable voltage circuit, variable or selectable current circuit, variable or selectable resistance, or other specific input variable (401, 501, 704, 804, 902, 1002, 1103, 1401, 1502, 1703, 1803, 1902, 2002) which may be used to control the driver circuits (102, 1102) variable or fixed output functions (200, 300) or output activations state (200, 300), or control properties required by the solid state lighting driver circuit (102, 1102) that may be used to provide the operation of a separately located solid state lighting emitters or fixtures (104, 105, 1104, 1105). This embodiment may be replicated to facilitate the integration of additional separately located solid state lighting emitters or fixtures (1104, 1105) and may include in an additional enclosure or housing (1106), where such enclosure or housing may be located (2101, 2201) to provide use functionality or user input.

In some embodiments, the solid state lighting control device (100, 1100) may contain two or greater (plurality) solid state lighting drivers (102, 1102) included in an enclosure or housing (106), where such enclosure or housing may be located to provide user input (401, 501, 1401, 1501) or functionality selections to a control circuit (103, 1103) that may interpret user inputs and then may process a logic schema, code or program or timer function that may control multiple outputs where each of these multiple outputs may separately or in unison may control a digital or analog circuit that may emulate a function or required input variable which may be a relay, gate, field effect transistor, electronic switch, variable or selectable voltage circuit, variable or selectable current circuit, variable or selectable resistance, or other specific input variable (401, 501, 704, 804, 902, 1002, 1103, 1401, 1502, 1703, 1803, 1902, 2002) which may be used to control the two or greater (plurality) solid state lighting driver circuits (102, 1102) variable or fixed output functions (200, 300) or output activations state (200, 300), or control properties required by the driver circuits, that may be used to provide the operation of separately located solid state lighting emitters or fixtures (104, 105, 1104, 1105). This embodiment may be replicated to facilitate the addition of additional separately located solid state lighting emitters or fixtures (1104, 1105) may include in an additional enclosure or housing (1106), where such enclosure or housing may be located (2101, 2201) to provide use functionality or user input.

In other embodiments, the solid state lighting control device may integrate a control feature where a user input (401, 1401) is mechanically affixed. This embodiment may be replicated to facilitate the integration of additional separately located solid state lighting emitters or fixtures (104, 105, 1104, 1105).

In this embodiment, the solid state lighting control device (100, 1100) may integrate a control feature where a remote control receiver (502, 1502), being capable of receiving user input (500, 1500) from a remote control transmitter (501, 1501), is incorporated. This embodiment may be replicated to facilitate the integration of additional separately located solid state lighting emitters or fixtures (104, 105, 1104, 1105).

In yet another embodiment, the solid state lighting control device (100, 1100) may integrate a control feature where the remote control transmitter (601, 1601) is incorporated, being capable of transmitting user input (500, 1600) and driver circuit state to a remote control receiver (602, 1602), is incorporated.

In other embodiments, the solid state lighting control device (100, 1100) may integrate a control feature where a microphone subsystem (701, 1704) is incorporated. The microphone (702, 1701), may be located outside of the enclosure (106, 1106) or the microphone (703, 1702), may be located inside of the enclosure (106, 1106). The microphone (702, 1701) shall be connected (705, 1705) to the audio processing circuit (704, 1703) with either a direct connection or a wireless connection.

In yet other embodiments, the solid state lighting control device (100, 1100) may integrate a control feature where a temperature detection subsystem (801, 1804) is incorporated. The temperature sensor (802, 1801), may be located outside of the enclosure (106, 1106) or the temperature sensor (803, 1802), may be located inside of the enclosure (106, 1106). The temperature sensor (802, 1801) shall be connected (805, 1805) to the temperature data processing circuit (804, 1803) with either a direct connection or a wireless connection.

In this embodiment, the solid state lighting control device may (100, 1100) may integrate a control feature where a security life safety device link (904, 1904) is incorporated. The security life safety device status (901, 1901) may be located outside of the enclosure (106, 1106). The security life safety device status (901, 1901) shall be connected (903, 1903) to the security life safety device processing mechanism (902, 1902) with either a direct connection or a wireless connection and where data communication may be singular in direction or bi-directional.

In other embodiments, the solid state lighting control device (100, 1100) may integrate a control feature where a building automation device link subsystem (1004, 2004) is incorporated. The building automation device status (1001, 2001) may be located outside of the enclosure (106, 1106). The building automation device status (1001, 2001) shall be connected (1003, 2003) to the building automation processing mechanism (1002, 2002) with either a direct connection or a wireless connection and where data communication may be singular in direction or bi-directional.

In this embodiment, the solid state lighting control device (100, 1100) that may contain an inbound power conversion circuit (101, 1101) in the same or separate enclosure (106, 1106) or which may be AC to DC or DC to DC, or both AC to DC with secondary DC to DC conversions.

In other embodiment, the solid state lighting control device (100, 1100) may integrate with another solid state lighting control device (100, 1100) through a data communication protocol that may be published data communication standard or may be a proprietary data communication standard and where communications transmission (1107) may be either a direct connection or a wireless connection and where connections data communication may be singular in direction or bi-directional.

What is claimed is:

1. A solid state lighting control device, comprising:
a power source;
a solid state lighting emitter driver circuit, powered by said power source;
a means of connecting one or more remotely located solid state lighting emitters to said driver circuit; and
a means of dynamically controlling said driver circuit, such that said one or more remotely located solid state lighting emitters emit between 0 and 100 per cent of maximum brightness.

2. The method of claim 1, wherein said solid state lighting emitter driver circuit is of a constant current type.

3. The method of claim 1, wherein said solid state lighting emitter driver circuit is of a pulse width modulation type.

4. The method of claim 1, wherein said means of dynamically controlling said driver circuit, further comprises a user input, said user input being mechanically affixed to said solid state lighting control device.

5. The method of claim 1, wherein said means of dynamically controlling said driver circuit, further comprises a remote control receiver, said remote control receiver being capable of receiving user input from a remote control transmitter.

6. The method of claim 1, wherein said means of dynamic control, further comprises a remote control transmitter, said remote control transmitter being capable of transmitting user input and driver circuit state to a remote control receiver.

7. The method of claim 1, wherein said means of dynamically controlling said driver circuit, further comprises a microphone subsystem, said microphone subsystem being comprised of a microphone and an audio processing circuit, said audio processing circuit being capable of deriving user input from audio input.

8. The method of claim 1, wherein said means of dynamically controlling said driver circuit, further comprises a temperature detection subsystem, said temperature detection subsystem being comprised of a temperature sensor and a temperature data processing circuit, said temperature data processing circuit being capable of deriving control input from temperature sensor data.

9. The method of claim 1, wherein said means of dynamically controlling said driver circuit, further comprises a security life safety device link subsystem, said security life safety device link subsystem being comprised of a means of decoding a security life safety device status and a processing mechanism capable of deriving control input from said decoded status info.

10. The method of claim 1, wherein said means of dynamically controlling said driver circuit, further comprises a building automation device link subsystem, said building automation device link subsystem being comprised of a means of decoding a building automation device status and a processing mechanism capable of deriving control input from said decoded status info.

11. The method of claim 1, further comprising:
one or more additional solid state lighting emitter driver circuits, powered by said power source;
a means of connecting one or more additional remotely located solid state lighting emitters to each said one or more additional driver circuits; and
a means of dynamically controlling said one or more additional driver circuits, such that said one or more additional remotely located solid state lighting emitters emit between 0 and 100 per cent of maximum brightness.

12. The method of claim 11, wherein said one or more additional solid state lighting emitter driver circuits are of a constant current type.

13. The method of claim 11, wherein said one or more additional solid state lighting emitter driver circuits are of a pulse width modulation type.

14. The method of claim 11, wherein said means of dynamically controlling said one or more additional driver circuits, further comprises a user input, said user input (401, 1406) being mechanically affixed to said solid state lighting control device.

15. The method of claim 11, wherein said means of dynamically controlling said one or more additional driver circuits, further comprises a remote control receiver, said remote control receiver being capable of receiving user input and driver circuit state from a remote control transmitter.

16. The method of claim 11, wherein said means of dynamic control, further comprises a remote control transmitter, said remote control transmitter being capable of transmitting control input and driver circuit state to a remote control receiver.

17. The method of claim 11, wherein said means of dynamically controlling said one or more additional driver circuits, further comprises a microphone subsystem, said microphone subsystem being comprised of a microphone and an audio processing circuit, said audio processing circuit being capable of deriving user input from audio input.

18. The method of claim 11, wherein said means of dynamically controlling said one or more additional driver circuits, further comprises a temperature detection subsystem, said temperature detection subsystem being comprised of a temperature sensor and a temperature data processing circuit, said temperature data processing circuit being capable of deriving control input from temperature sensor data.

19. The method of claim 11, wherein said means of dynamically controlling said one or more additional driver circuits, further comprises a security life safety device link subsystem, said security life safety device link subsystem being comprised of a means of decoding a security life safety device status and a processing mechanism capable of deriving control input from said decoded status info.

20. The method of claim 11, wherein said means of dynamically controlling said one or more additional driver circuits, further comprises a building automation device link subsystem, said building automation device link subsystem being comprised of a means of decoding a building automation device status and a processing mechanism capable of deriving control input from said decoded status info.
